(19) United States
(12) Patent Application Publication
(10) Pub. No.: US 2026/0063176 A1
(43) Pub. Date: Mar. 5, 2026

(54) POWER MODULE FOR A HOLLOW SENSORIZED ROLLER AND ASSOCIATED HOLLOW SENSORIZED ROLLER AND ROLLER BEARING

(71) Applicant: AKTIEBOLAGET SKF, GOTEBORG (SE)

(72) Inventors: Andreas Clemens VAN DER HAM, Warnsveld (NL); Kishor Kamalakar POWAR, Bangalore (IN); Alexandre André Roland TAILLEPIED, Fondettes (FR)

(21) Appl. No.: 19/312,657

(22) Filed: Aug. 28, 2025

(30) Foreign Application Priority Data
Sep. 4, 2024 (IN) 202441067015

(51) Int. Cl. F16C 41/00; F16C 19/06; F16C 19/38

(52) U.S. Cl. CPC F16C 41/004; F16C 19/06; F16C 19/38; F16C 2233/00; F16C 2380/26

(57) ABSTRACT

A device configured to be mounted in an axial central bore of a hollow sensorized roller includes a power module housing having a body having a first end closed by an end cap and an open second end and an adapter configured to connect the power module housing to a sensing module. The adapter includes a mounting base extending into the open second end of the power module housing, an end portion and a central portion. A power module is mounted in the power module housing and includes an electric generator having a rotor, a stator, and shaft supported by a first bearing in the end cap and a second bearing in the adapter. The stator includes a coil and a flux guide surrounding the rotor, and a portion of the flux guide is located axially between the rotor and the mounting base.

### CROSS-REFERENCE

This application claims priority to Indian patent application no. 202441067015 filed on Sep. 4, 2024, the contents of which are fully incorporated herein by reference.

### TECHNOLOGICAL FIELD

The present disclosure is directed to the monitoring of rolling bearing and more particularly to a sensorized roller for monitoring a rolling bearing and a housing of such a sensorized roller.

### BACKGROUND

It is known to implement a sensorized roller in a rolling bearing to perform condition monitoring of the rolling bearing. Such a sensorized roller comprises a housing enclosing a sensing module including measurement devices for measuring deformation of the roller and electronics for processing a deformation signal from the measuring devices, and an antenna module for wirelessly transmitting the processed deformation signal to an external receiver.

To supply the measurement devices, the housing further enclosed a harvesting module to generate power from movements of the roller and providing the power to the measurement devices. The harvesting module comprises an electrical generator generating electrical power from the rotation of the sensorized roller. The electrical generator comprises an eccentric mass fixed to a main shaft extending along a longitudinal axis of the roller, a stator rigidly fixed inside the harvesting module and configured to be rotated by the rotation of the sensorized roller. The electrical generator further comprises a rotor fixed to the main shaft and being in the stator. Bearings support the main shaft.

To generate enough energy to supply the sensing module, the electrical generator must be as powerful as possible and have a size permitting its arrangement in the harvesting module.

### SUMMARY

Consequently, the present disclosure is directed to an electrical generator arranged in the harvesting module that is configured to generate more power than an electrical generator known from the prior. According to an aspect, a housing configured to be fitted within a through axial central bore of a hollow sensorized roller is also disclosed.

The housing comprises a power module and an adapter supporting the power module. The power module has an end cap, and the adapter has a mounting base onto which is mounted a first end of the end cap of the power module. A second end of the end cap includes a bore housing a first bearing, and the mounting base of the adapter includes a bore housing a second bearing. The power module further comprises an electrical generator comprising a main shaft supported by the first and second bearings and extending along a longitudinal axis of the housing, an eccentric mass fixed to the main shaft, a rotor fixed to the main shaft, and a stator fixed inside the end cap. The stator comprises at least one stator coil and flux guides encompassing the rotor to concentrate and guide the magnetic flux of the rotor through the stator coil, being axially located between the rotor and the mounting base and configured to be rotated by the rotation of the sensorized roller.

The flux guides axially redirect the radial magnetic flux of the rotor to pass through the stator coil so that the electrical generator delivers more power than a generator known from the prior art. Preferably, the stator comprises stator coils and flux guides encompassing the rotor to concentrate and guide the magnetic flux of the rotor through the stator coils. Advantageously, the rotor comprises a magnetic ring.

Preferably, the first and second bearings are deep groove ball bearings.

Advantageously, the housing further comprises a sensing module comprising a tubular housing and anti-rotation means, the adapter being provided with a front face in axial contact with a first end of the tubular housing of the sensing module, the anti-rotation means being supported by the front face of the adapter and being inserted into the tubular housing of the sensing module to avoid a rotation of the housing relative to the adapter.

Preferably, the adapter comprises an axial through-hole inside which a wire passes through to electrically connect the power module and the sensing module.

Advantageously, the anti-rotation means comprise a non-circular part protruding relative to the front face and inserted into an aperture of the tubular housing of the sensor module having a complementary shape of the non-circular part.

Preferably, the housing further comprises securing means configured to axially secure the adapter and the tubular housing of the sensor module.

Advantageously, the adapter is provided with a mounting base onto which is mounted the end cap of the power module, the housing further comprises fixing means to secure the mounting base and the end cap of the power module.

Another aspect of the disclosure comprises a device configured to be mounted in an axial central bore of a hollow sensorized roller. The device comprises a power module housing comprising a body having a first end closed by an end cap and an open second end, the end cap including a first bore and a first bearing mounted in the first bore. The device also includes an adapter configured to connect the power module housing to a sensing module, the adapter comprising a mounting base extending into the open second end of the power module housing, an end portion and a central portion located between the mounting base and the end portion. The adapter has a second bore and a second bearing in the second bore. A power module is located in the power module housing and comprises an electric generator including a main shaft supported by the first bearing and the second bearing and extending along a longitudinal axis of the power module housing, an eccentric mass fixed to the main shaft, a rotor fixed to the main shaft, and a stator fixed inside the power module housing. The stator includes at least one stator coil and a flux guide surrounding the rotor, the flux guide being configured to concentrate and guide a magnetic flux of the rotor through the stator coil. A portion of the flux guide is located axially between the rotor and the mounting base, and the flux guide is rotationally fixed relative to the housing.

According to another aspect, a hollow sensorized roller for a rolling bearing is provided. The hollow sensorized roller comprises a roller body having an axial central bore and a housing as defined above, the housing being fitted within the axial central bore of the roller body.

According to another aspect, a rolling bearing is disclosed. The rolling bearing comprises a stationary ring and a rotatable ring configured to rotate concentrically relative to one another, and at least one row of rolling elements interposed between a first raceway and a second raceway respectively provided on the first and second rings, one rolling element being a hollow sensorized roller as defined above.

### BRIEF DESCRIPTION OF THE DRAWINGS

Other advantages and features of the disclosure will appear on examination of the detailed description of embodiments, in no way restrictive, and the appended drawings in which:

FIG. 1 is a sectional view of a roller bearing according to an embodiment of the present disclosure.

FIG. 2 is an exploded perspective view of a hollow sensorized roller according to an embodiment of the disclosure.

FIG. 3 is a perspective view, partly in section, of a housing of the hollow sensorized roller of FIG. 2.

FIG. 4 is a sectional elevation view of the hollow sensorized roller of FIG. 2.

FIG. 5 is a perspective view of an adapter of the housing of FIG. 3.

FIG. 6 is a perspective view of an adapter of the housing of FIG. 6.

### DETAILED DESCRIPTION

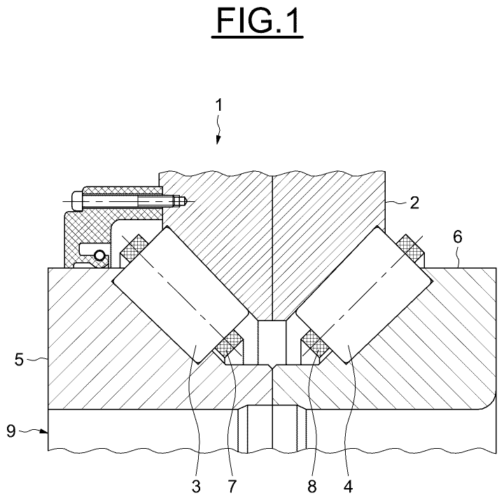

Reference is made to FIG. 1 which represents schematically an example of a roller bearing 1. The bearing 1 is a tapered roller bearing and comprises an outer ring or stationary ring 2 having conical first and second outer raceways (unnumbered) for supporting a first row 3 and a second row 4 of rolling elements, in this case, tapered rollers. The bearing 1 further includes a rotatable inner ring formed from a first ring 5 and a second, axial adjacent second ring 6, which are respectively provided with conical first and second inner raceways for the first and second roller rows 3, 4 of rolling elements. In addition, the bearing 1 further comprises a first cage 7 for retaining the rollers of the first row 3 of rollers and a second cage 8 for retaining the rollers 4 of the second row of rollers. Typically, the cages may be formed from segments that abut each other in the circumferential direction.

To provide the necessary stiffness and ensure a long service life, the bearing is preloaded. The axial position of the rotatable rings 5, 6 relatives to the stationary ring 2 is set such that the first and second roller sets 2, 4 have a negative internal clearance (i.e., a preload). In a variant, the bearing 1 may comprise a spherical roller bearing or a cylindrical roller bearing that is not preloaded.

In the depicted bearing, at least one of the rolling elements in either of the first and second roller rows 3, 4 is replaced with a hollow sensorized roller. The first and second rotatable rings 5, 6 are mounted on a shaft 9.

The disclosed rolling bearing 1 comprises tapered rollers. In another embodiment, the rolling bearing 1 may comprise other types of rolling elements, for example cylindrical rollers or spherical rollers. The rolling bearing 1 may also comprise only one row of rolling elements or more than two rows of rolling elements, the number of cages being determined according to the number of rows.

The rolling bearing 1 comprising a row of rolling elements comprises a unique inner ring. In another embodiment, the outer ring 2 is the rotatable ring and the inner rings 5, 6 are the stationary rings.

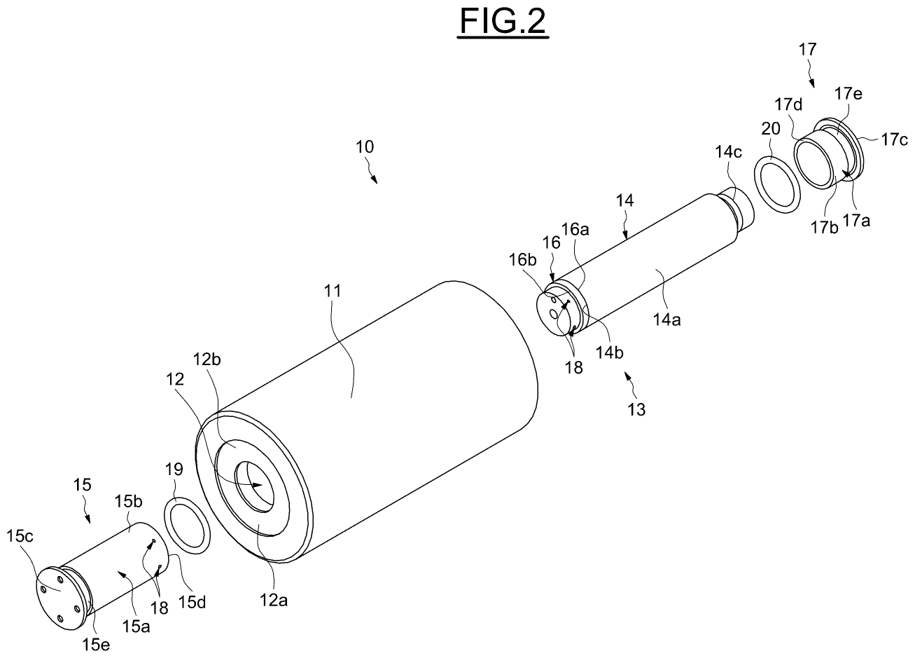

FIG. 2 illustrates schematically an example of the hollow sensorized roller 10. The hollow sensorized roller 10 comprises a roller body 11 having a through axial central bore 12, and a housing (device) 13 mounted in the central bore 12 that extends through the roller body 11.

Each end of the through axial central bore 12 comprises an axial centering portion 12a, a conical portion 12b and a radial shoulder (not represented). The conical portion 12b extends obliquely outward from a first end of the centering portion 12a, and the radial shoulder extends radially inwards from a second end of the centering portion 12a.

The housing 13 is formed from a sensor module 14, a power module 15, an adapter 16 supporting the power module 15 and the sensor module 14 and an end part 17. The sensor module 14 comprises a tubular sensor module housing 14a, and the power module 15 comprises a body 15a inserted into a first end of the bore 12 of the roller body 11.

A first annular sealing element 19 is interposed between the body 15a of the power module 15 and the bore 12 of the roller body 11. The sensor module 14 is formed from two semi-cylindrical housing halves which are held together axially by the end cap 17 and the adapter 16. Screws and dowel pins (not represented) radially connect together the two semi-cylindrical housing halves.

The sensor module 14 houses at least one sensor (not represented on FIG. 2) for measuring parameters relating to the condition of the hollow sensorized roller. The sensor is secured to the tubular housing 14a of the sensor module 14 and comprises for example a load sensor for measuring a load distribution across the hollow sensorized roller.

The sensor module 14 further houses an antenna (not represented) secured to the tubular housing 14a of the sensor module 14. The sensor module 14 may further house a wireless transmitter (not represented) connected to the antenna to transmit the measurements of the sensor to a processing device (not represented) located outside the bearing for processing the measurements.

The body 15a of the power module 15 comprises a cylindrical body 15b and an end cap 15c extending radially outwards the cylindrical body 15b.

The first annular sealing element 19 is radially interposed between the cylindrical body 15b of the body 15a and the bore 12 of the roller body 11 and axially interposed between the end cap 15c of the body 15a and the bore 12 of the roller body 11.

The adapter 16 has a central portion 16a in axial contact with a first end 14b of the tubular housing 14a of the sensor module 14. The adapter 16 also includes a mounting base 16b onto which is mounted a first end 15b of the body 15a of the power module 15. The end cap 15c of the body 15a is secured to the second end of the cylindrical body 15b of the body 15a. A groove 15e is formed onto the cylindrical body 15b of the body 15a of the power module 15. The first annular sealing element 19 is located partly inside the groove 15e.

The housing 13 further comprises anti-rotation means (end portion) supported by the central portion 16a of the adapter 16 and inserted into the tubular housing 14a of the sensor module 14 to prevent a rotation of the tubular housing 14a relative to the adapter 16.

The housing 13 further comprises fixing means 18 to secure the mounting base 16b and the first end 15b of the body 15a of the power module 15.

The end part 17 comprises an end cap 17a inserted into a second end of the bore 12 of the roller body 11. A second annular sealing element 20 is interposed between the end cap 17a of the end part 17 and the bore 12 of the roller body 11. The end cap 17a of the end part 17 comprises a cylindrical body 17b and an end portion 17c extending outwards the cylindrical body 17b.

The second annular sealing element 20 is radially interposed between the cylindrical body 17b of the end part 17 and the bore 12 of the roller body 11 and axially interposed between the end portion 17c of the end cap 17a of the end part 17 and the bore 12 of the roller body 11. A first end 17d of the cylindrical body 17b of the end cap 17a of the end part 17 is secured to a second end 14c of the tubular housing 14c of the sensor module 14. The cylindrical body 17b of the end cap 17a of the end part 17 may be clipped on the end 14c of the tubular housing 14a of the sensor module 14. A groove 17e is formed onto the cylindrical body 17b of the end cap 17a of the end part 17. The second annular sealing element 20 is located partly inside the groove 17e.

The housing 13 as a whole is shaped to fit within the roller bore 12 and is mounted to and located in the bore 12 by means of the first and second sealing elements 19, 20.

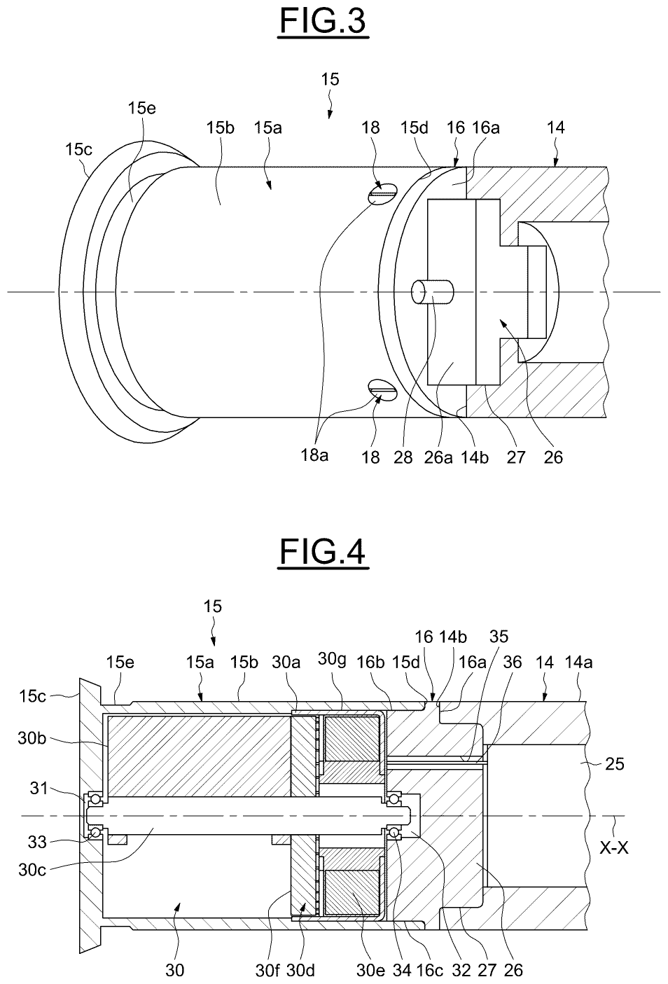

FIGS. 3 and 4 illustrate respectively a partial view and a longitudinal cross section of an example of the sensor module 14 and the power module 15. The sensor and antenna are housed in the sensor module 14 and identified by reference number 25 in FIG. 4. The anti-rotation means comprise a non-circular part 26 protruding relative to the central portion 16a and supported by the central portion 16a. The first end 14b of the sensor module 14 further comprises an aperture 27 having a complementary shape of the non-circular part 26. The non-circular part 26 is inserted into the non-circular aperture 27 to prevent a rotation of the housing 14a of the sensor module 14 relative to the adapter 16. The non-circular part 26 may be rectangular, triangular, square, hexagonal, star shaped or another shape so that the adapter 16 does not rotate relative the tubular housing 14a of the sensor module 14.

The housing 13 further comprises securing means to axially secure the adapter 16 and the first end 14b of the tubular housing 14a of the sensor module 14. The securing means comprises at least first and second pins 28, 29 supported by the non-circular part 26. A first end of the first pin 28 is inserted into a first lateral face 26a of the non-circular part 26 and a first end of the second pin 29 being inserted into a second lateral face 26b of the non-circular part 26.

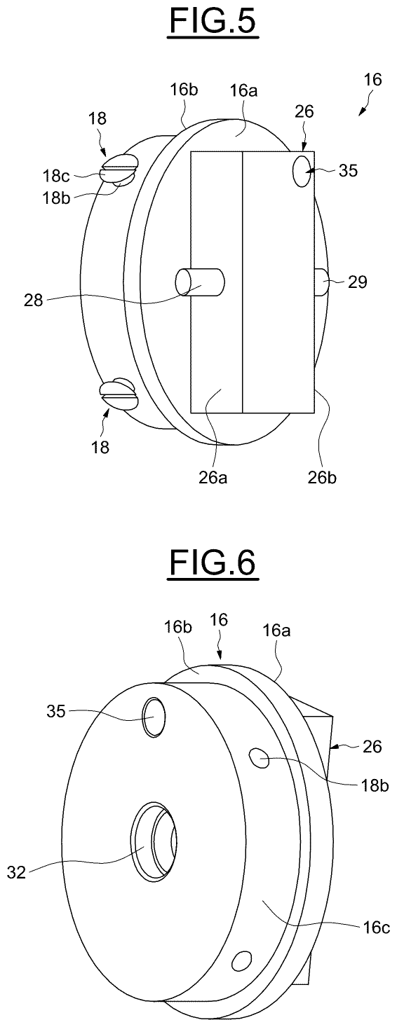

The second lateral face 26b of the non-circular part 26 is opposed to the first lateral face 26a of the non-circular part 26. The second end of the first and second pins 28, 29 is inserted into the tubular housing 14a of the sensor module 14. The second pin 29 and the second lateral face 27b of the rectangular part 27 are represented in FIG. 5.

The power module 15 may house an energy harvester. The energy harvester comprises for example an electrical generator 30 having an axis along a longitudinal axis X-X of the hollow sensorized roller 10. The electrical generator 30 produces energy from the rotation of the hollow sensorized roller 10.

The electrical generator 30 comprises a stator 30a rigidly fixed to the cylindrical body 15b of the body 15a of the power module 15, an eccentric mass or weight 30b rigidly fixed to a main shaft 30c having an axis along the first axis X-X, a rotor 30d fixed to the shaft 30c and a stator coil 30e mounted in the stator 30a and configured to be rotated by the rotation of the hollow sensorized roller 10. The stator coil 30e forms one single stator pole.

The rotor 30d comprises a magnetic ring 30f comprising for example permanent magnets.

The eccentric mass 30b is driven by gravity G and centrifugal force to maintain the main shaft 30c of the generator 30 when rotation of the hollow sensorized roller 10 along the first rotation axis X-X. The rotation of the hollow sensorized roller drives the rotation of the stator 30a and thus the stator coil 30e of the generator 30.

The stator 30a extends from the rotor 30d to the mounting base 16b. The stator 30 may include flux guides 30g encompassing the rotor 30d to guide the magnetic flux. The passage of the magnetic ring 30f in front of the flux guides 30g generates an electromotive force between the ends of the coil 30e.

The power generated by the electric generator 30 depends on the magnetic flux going through the coil 30e. The flux guides 30g concentrate and guide the magnetic flux of the rotor 30d through the stator coil 30e of the stator 30a so that the stator coil 30e generates a higher electromotive force. The flux guides 30g axially redirect all the magnetic flux of the magnetic ring 30f so that the magnetic flux passes through the stator coil 30e. The arrangement of the stator 30a, the rotor 30d and the flux guides 30g in the power module 15 form a generator generating more power than a generator known from the prior art for an identic encumbrance of the generators.

In variant, the electrical generator 30 may comprise a plurality of stator poles, the generator 30 being for example a multi-pole brushless DC electric motor BLDC.

The end portion 15c of the end cap 15 of the power module 15 and the mounting base 16b of the adapter 16 comprise a bore 31, 32 housing a bearing 33, 34 supporting the main shaft 30c of the electrical generator 30 limiting friction of the main shaft 30c. The bearings 33, 34 limit axial and radial displacements of the main shaft 30c reducing the airgap between the magnetic ring 30f and the flux guides 30g. The limitation of the axial and radial displacements of the main shaft 30c further prevents collisions between the magnetic ring 30f and the flux guides 30g, and prevents collisions between the eccentric mass 30b and the tubular housing 15a of the power module 15. The bearings 33, 34 may comprise deep groove ball bearings.

The adapter 16 further comprises an axial through-hole 35 inside which a wire 36 passes through to electrically connect the power module 15 and the sensor module 14. As the power module 15 and the sensor module 14 are secured together in such a manner that the power module 15 cannot rotate compared with the sensor module 14, the wire 32 cannot be damaged.

FIGS. 5 and 6 illustrate views of the example of adapter 16 illustrated in FIGS. 3 and 4. The mounting base 16b of the adapter 16 comprises a circumferential surface 16c onto which is mounted the body 15a of the power module 15. The fixing means 18 comprise a first set of through-holes 18a in a lateral face of the body 15a of the power module 15 (represented in FIG. 3), a second set of holes 18b in the circumferential surface 16c and a plurality of screws 18c. Each screw 18c passes through one of the through-holes 18a of the first set and being engaged in one of the holes 18b of the second set. The adapter 16 permits to robustly secure the power module 15 to the sensor module 14 in a removable manner and to simplify the mounting of the hollow sensorized roller 10.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sensorized rolling elements.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A device configured to be mounted in an axial central bore of a hollow sensorized roller, the device comprising:
a power module housing comprising a body having a first end closed by an end cap and an open second end, the end cap including a first bore and a first bearing mounted in the first bore,
an adapter configured to connect the power module housing to a sensing module, the adapter comprising a mounting base extending into the open second end of the power module housing, an end portion and a central portion located between the mounting base and the end portion, the adapter having a second bore and a second bearing in the second bore, and
a power module in the power module housing, the power module comprising an electric generator including a main shaft supported by the first bearing and the second bearing and extending along a longitudinal axis of the power module housing, an eccentric mass fixed to the main shaft, a rotor fixed to the main shaft, and a stator fixed inside the power module housing,
wherein the stator includes at least one stator coil and a flux guide surrounding the rotor, the flux guide being configured to concentrate and guide a magnetic flux of the rotor through the stator coil,
wherein a portion of the flux guide is located axially between the rotor and the mounting base, and
wherein the flux guide is rotationally fixed relative to the housing.

2. The device according to claim 1,
wherein the rotor includes a plurality of permanent magnets.

3. The device according to claim 1,
wherein the first bearing and the second bearing are deep groove ball bearings.

4. The device according to claim 1,
further comprising the sensing module,
wherein the sensing module comprises a tubular sensing module housing,
wherein the central portion of the adapter abuts against a first end of the sensing module housing, and
wherein the end portion of the adapter engages a non-circular opening in the sensing module to prevent relative rotation between the adapter and the sensing module housing.

5. The device according to claim 4,
wherein the adapter comprises an axial through-hole, and
wherein a wire electrically connects the power module to the sensing module and extends through the through-hole.

6. The device according to claim 4,
wherein the end portion of the adapter comprises a projection having a shape complementary to a shape of the non-circular opening.

7. The device according to claim 6, further comprising securing means configured to axially secure the adapter to the power module.

8. A hollow sensorized roller for a rolling bearing having an axial central bore and a device according to claim 1 mounted in the axial central bore.

9. A rolling bearing comprising:
a stationary first ring,
a rotatable second ring, and
at least one row of rolling elements interposed between a first raceway of the stationary first ring and a second raceway rotatable second ring,
wherein one rolling element of the at least one row of rolling elements comprises a hollow sensorized roller according to claim 8.
